(19) United States
(12) Patent Application Publication
(10) Pub. No.: US 2024/0195447 A1
(43) Pub. Date: Jun. 13, 2024

(54) PERSONAL ELECTRONIC DEVICE SUPPORT STAND ASSEMBLY

(71) Applicant: Gilbert Baca, Santa Fe, NM (US)

(72) Inventor: Gilbert Baca, Santa Fe, NM (US)

(21) Appl. No.: 18/077,317

(22) Filed: Dec. 8, 2022

(51) Int. Cl. H04B 1/3877; H04M 1/04

(52) U.S. Cl. CPC H04B 1/3877; H04M 1/04

(57) ABSTRACT

A personal electronic device support stand assembly for having a rod extend from a tube to support a device includes a tube having a back side, a front side, a top end, and a bottom end. A rod is elongated and is resiliently flexible and removably extendable from the tube and supports a personal electronic device in an upright orientation. The rod has a first end and a second end. A pair of stops is attached to the tube and each of the top and bottom ends includes one of the stops. The stops are positionable in a first position preventing passage of the first and second ends outwardly of the tube and a second position allowing passage of the first and second ends outwardly of the tube. An adhesive pad is coupled to the back side and adheres the tube to a back surface of the personal electronic device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to electronic device support stands and more particularly pertains to a new electronic device support stand for having a rod extend from a tube to support a device.

### (2) Description of Related Art Including Information Disclosed Under 37 CFR 1.97 and 1.98

The prior art relates to electronic device support stands and includes a variety of electronic device support stands being configured to support a personal electronic device in an upright orientation. Known prior art does not include a tube adhering to the personal electronic device and a rod extending from the tube to retaining a manipulated shape to support the personal electronic device in the upright orientation.

### BRIEF SUMMARY OF THE INVENTION

An embodiment of the disclosure meets the needs presented above by generally comprising a tube has a back side, a front side, a top end being open, and a bottom end being open. A rod is elongated and is resiliently flexible and retains a manipulated shape. The rod is removably extendable from the tube and is configured to support a personal electronic device in an upright orientation. The rod has a first end and a second end. A pair of stops is attached to the tube and each of the top and bottom ends includes one of the stops. The stops are positionable in a first position preventing passage of the first and second ends outwardly of the tube and the stops are positionable in a second position allowing passage of the first and second ends outwardly of the tube. An adhesive pad is coupled to the back side and is configured for removably adhering the tube to a back surface of the personal electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a personal electronic device support stand assembly according to an embodiment of the disclosure.

FIG. 2 is a rear view of an embodiment of the disclosure.

FIG. 3 is a side view of an embodiment of the disclosure.

FIG. 4 is a top view of an embodiment of the disclosure.

FIG. 5 is a bottom view of an embodiment of the disclosure.

FIG. 6 is a detail view of an embodiment of the disclosure taken from Magnified Circle 6 of FIG. 4.

FIG. 7 is an in-use view of an embodiment of the disclosure.

FIG. 8 is an in-use view of an embodiment of the disclosure.

FIG. 9 is an in-use view of an embodiment of the disclosure.

FIG. 10 is an in-use view of an embodiment of the disclosure.

FIG. 11 is an in-use view of an embodiment of the disclosure.

FIG. 12 is an in-use view of an embodiment of the disclosure.

FIG. 13 is a detail view of an embodiment of the disclosure taken from Magnified Circle 13 of FIG. 1.

FIG. 14 is an in-use view of an embodiment of the disclosure.

### DETAILED DESCRIPTION OF THE INVENTION

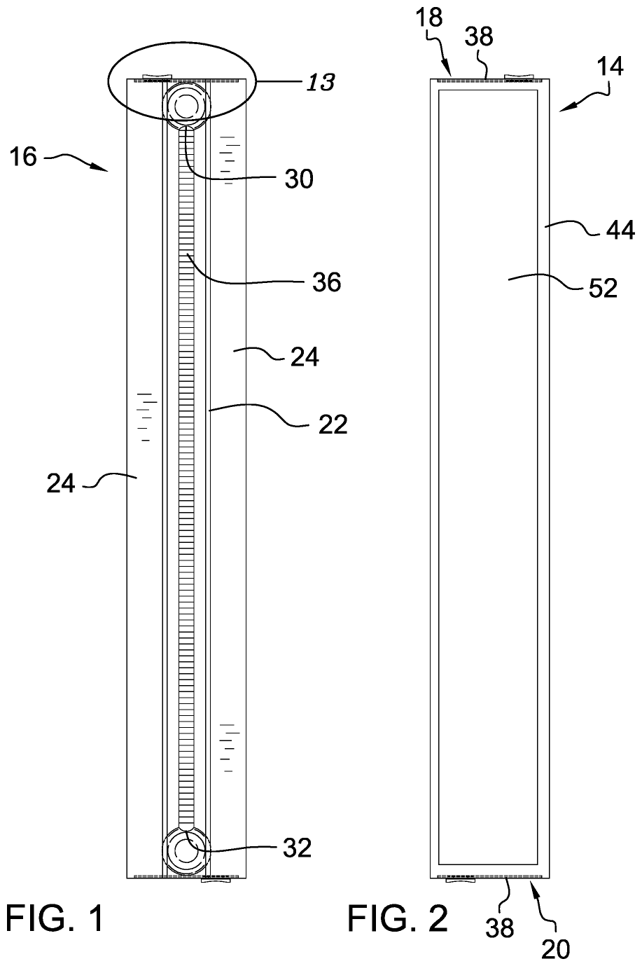

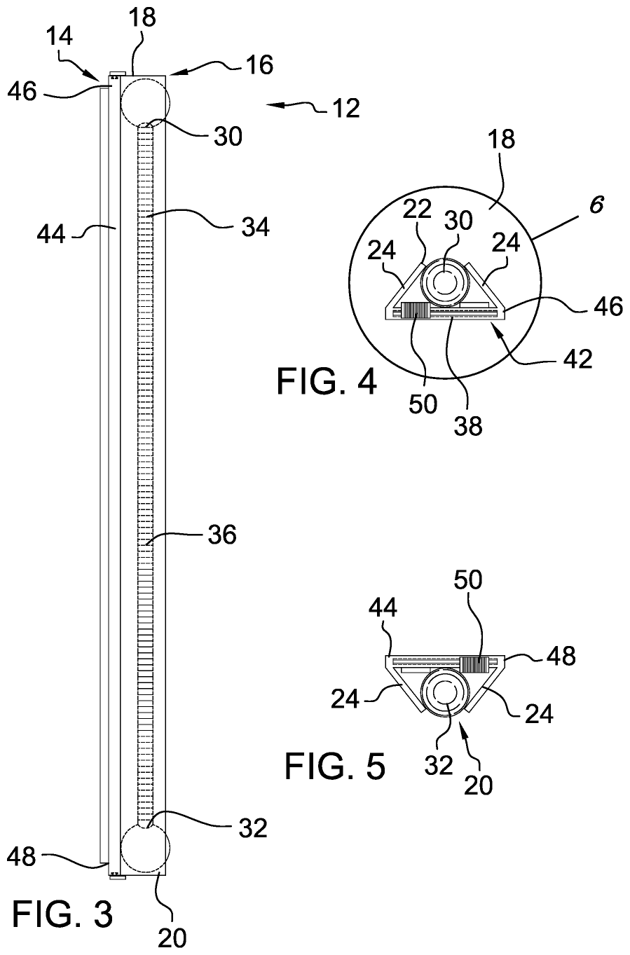

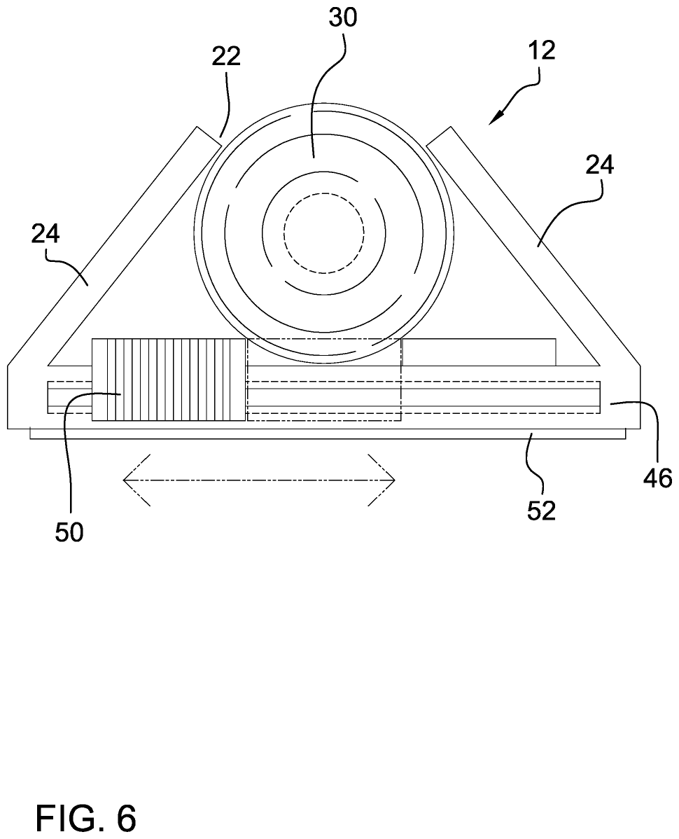

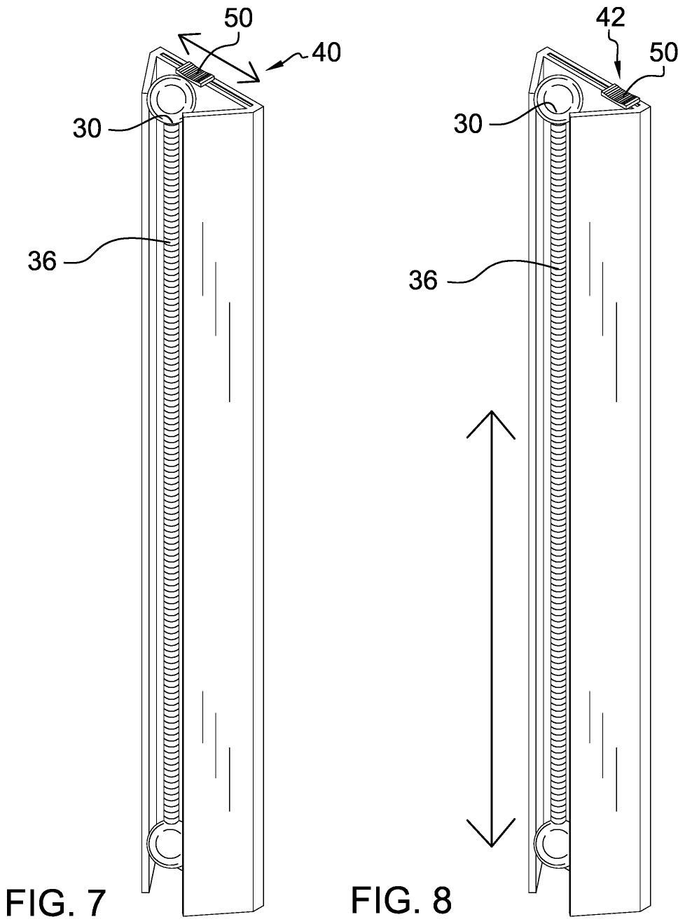

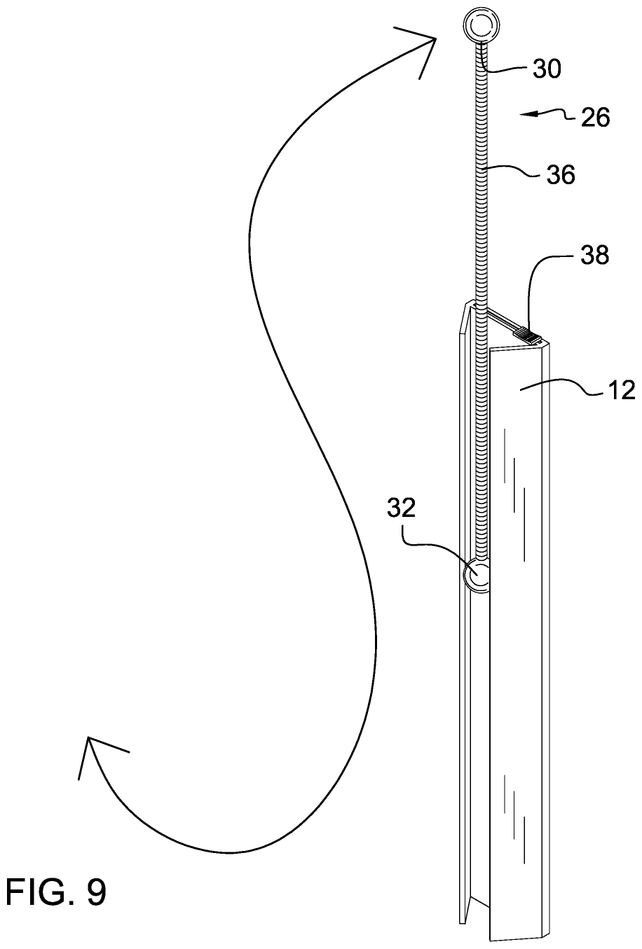

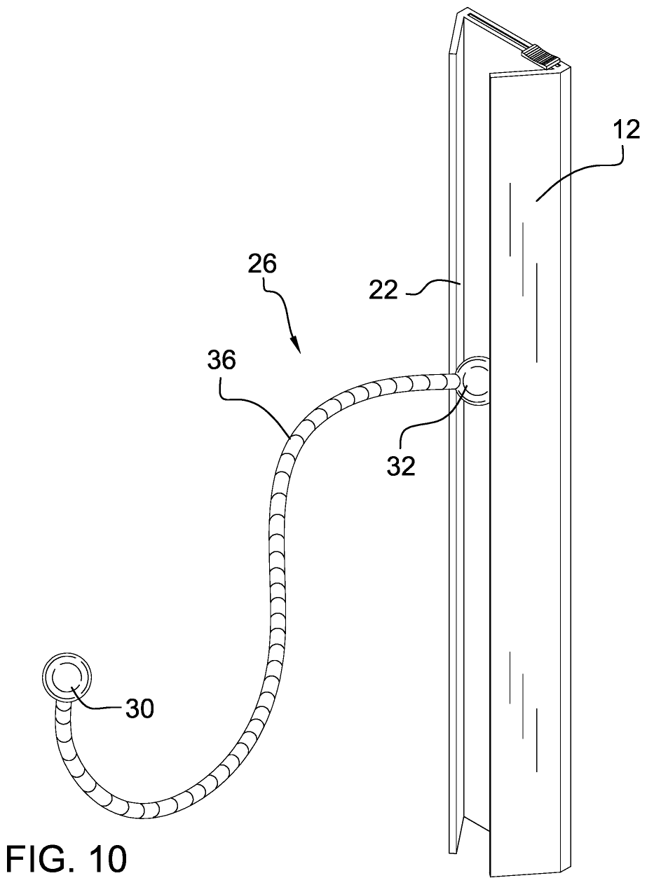

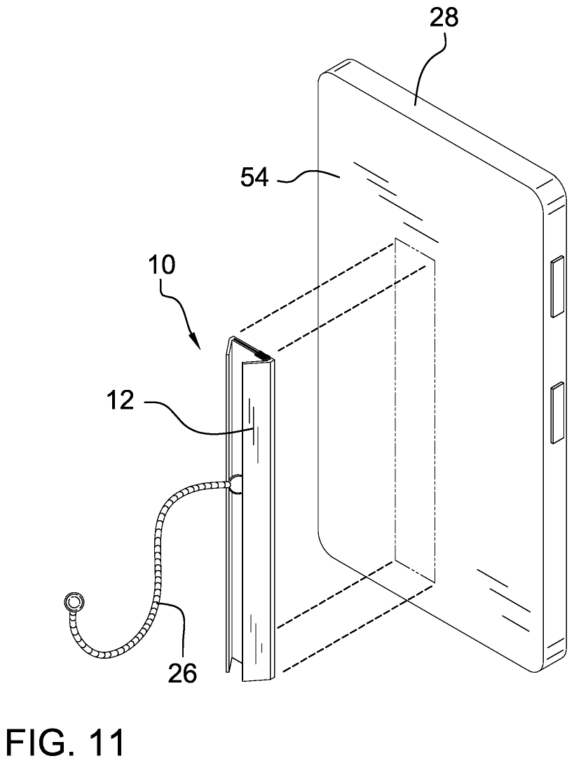

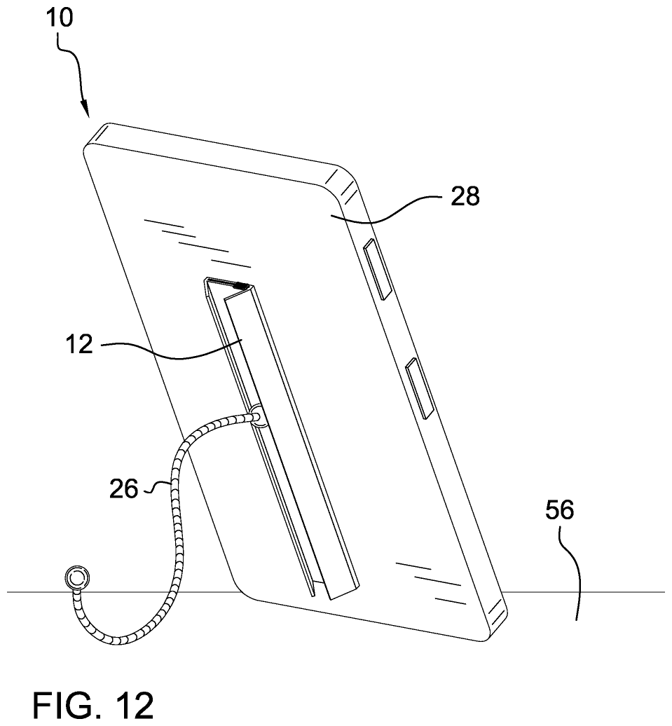

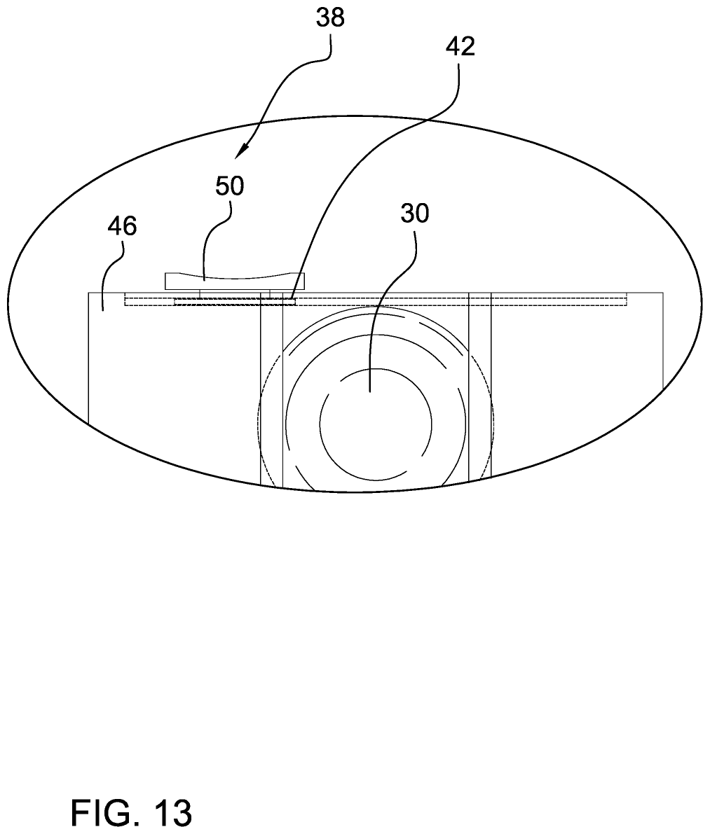

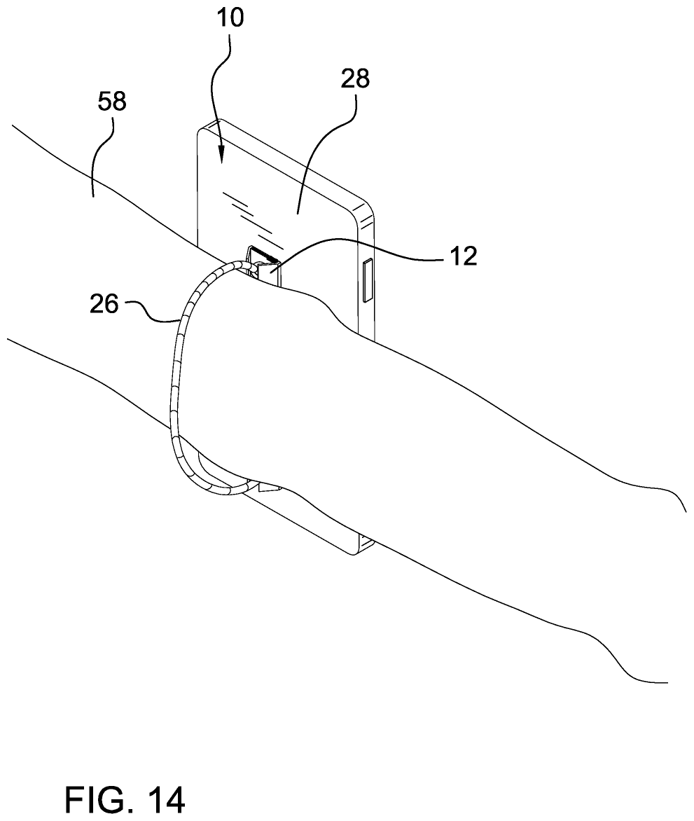

With reference now to the drawings, and in particular to FIGS. 1 through 14 thereof, a new electronic device support stand embodying the principles and concepts of an embodiment of the disclosure and generally designated by the reference numeral 10 will be described.

As best illustrated in FIGS. 1 through 14, the personal electronic device support stand assembly 10 generally comprises a tube 12 having a back side 14, a front side 16, a top end 18 being open, and a bottom end 20 being open. The front side 16 has an elongated slot 22 extending therethrough and though the top 18 and bottom 20 ends. A pair of side walls 24 is defined on opposite sides of the slot 22 and each of the side walls 24 is planar and is angled toward each other to define the slot 22.

A rod 26 is elongated and is resiliently flexible and retains a manipulated shape. The rod 26 may be a conventional “gooseneck tube” commonly available in a variety of sizes. The rod 26 is removably extendable from the tube 12 and is configured to support a personal electronic device 28 in an upright orientation. The rod 26 has a first end 30 and a second end 32 and the rod 26 is extendable from the slot 22 such that the first end 30 or the second end 32 selectively is retained within the tube 12. The first 30 and second 32 ends are extendable through the top 18 or bottom 20 ends of the tube 12 and an entirety of the rod 26 is positionable within the tube 12 to define a stored position 34 of the tube 12. The first 30 and second 32 ends each are bulbous and have a diameter greater than a width of the slot 22 to inhibit passage of the first 30 or the second 32 ends through the slot 22. A body 36 of the rod 26 positioned between the first 30 and second 32 ends has a diameter less than the width of the slot 22 to allow the body 34 to slide along a length of the slot 22.

A pair of stops 38 is attached to the tube 12 and each of the top 18 and bottom 20 ends includes one of the stops 36. The stops 38 are positionable in a first position 40 to prevent passage of the first 30 and second 32 ends outwardly of the tube 12. The stops 38 are positionable in a second position 42 to allow passage of the first 30 and second 32 ends outwardly of the tube 12. The back side 14 includes a back wall 42 including an upper edge 46 and lower edge 48. Each of the stops 38 may comprise a slide 50 attached to an associated one of the upper 46 and lower 48 edges. The slides 50 are slidable from the first position 40 adjacent to one of the side walls 24 to the second position 42 spaced from the side walls 24 and extending over an associated one of the top 18 and bottom 20 ends. An adhesive pad 52 is coupled to the back side 14 and is configured for removably adhering the tube 12 to a back surface 54 of the personal electronic device 28.

In use, the back side 14 of the tube 12 is adhered to the back surface 54 of the personal electronic device 40. The stops 38 may be positioned into the second position 40 to allow passage to the first end 30 or the second end 32 selectively for removing from the tube 12. The stops 38 may then be positioned into the first position 40 when one of the first 30 or second 32 ends has been removed from the tube 12 and the rod 26 is extended outwardly from the tube 12. The rod 26 may be formed into a manipulated shape to retain the personal electronic device 28 in an upright position upon a surface 56 such as a table. The rod 26 may also be formed into a manipulated shape to hang the personal electronic device 28 from a hanging member 58 such as a hook or a tree branch.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A support stand assembly configured for supporting a personal electronic device in an angled position on a horizontal support surface, said support stand assembly comprising:
a tube having a back side and a front side, said tube having a top end being open and a bottom end being open;
a rod being elongated, said rod being resiliently flexible and retaining a manipulated shape, said rod being removably extendable from said tube and being configured to support the personal electronic device in an upright orientation, said rod having a first end and a second end;
a pair of stops being attached to said tube, each of said top and bottom ends including one of said stops, said stops being positionable in a first position preventing passage of said first and second ends outwardly of said tube, said stops being positionable in a second position allowing passage of said first and second ends outwardly of said tube; and
an adhesive pad being coupled to said back side and being configured for removably adhering the tube to a back surface of the personal electronic device.

2. The support stand assembly of claim 1, wherein said front side has an elongated slot extending therethrough and though said top and bottom ends, a pair of side walls being defined on opposite sides of said slot, each of said side walls being planar and being angled toward each other to define said slot.

3. The support stand assembly of claim 2, wherein said rod is extendable from said slot such that said first end or said second end selectively is retained within said tube, said first and second ends being extendable through said top or bottom ends of said tube, an entirety of said rod being positionable within said tube to define a stored position of said tube, said first and second ends each being bulbous and having a diameter greater than a width of said slot to inhibit passage of said first or second ends through said slot, a body of said rod positioned between said first and second ends having a diameter being less than the width of the slot to allow the body to slide along a length of said slot.

4. The support stand assembly of claim 3, wherein said back side includes a back wall including an upper edge and lower edge, each of said stops comprising a slide attached to an associated one of said upper and lower edges, said slides being slidable from the first position adjacent to one of said side walls to said second position spaced from said side walls and extending over an associated one of said top and bottom ends.

5. A support stand assembly configured for supporting a personal electronic device in an angled position on a horizontal support surface, said support stand assembly comprising:
a tube having a back side and a front side, said tube having a top end being open and a bottom end being open, said front side having an elongated slot extending therethrough and though said top and bottom ends, a pair of side walls being defined on opposite sides of said slot, each of said side walls being planar and being angled toward each other to define said slot;
a rod being elongated, said rod being resiliently flexible and retaining a manipulated shape, said rod being removably extendable from said tube and being configured to support the personal electronic device in an upright orientation, said rod having a first end and a second end, said rod being extendable from said slot such that said first end or said second end selectively is retained within said tube, said first and second ends being extendable through said top or bottom ends of said tube, an entirety of said rod being positionable within said tube to define a stored position of said tube, said first and second ends each being bulbous and having a diameter greater than a width of said slot to inhibit passage of said first or second ends through said slot, a body of said rod positioned between said first and second ends having a diameter being less than the width of the slot to allow the body to slide along a length of said slot;
a pair of stops being attached to said tube, each of said top and bottom ends including one of said stops, said stops being positionable in a first position preventing passage of said first and second ends outwardly of said tube, said stops being positionable in a second position allowing passage of said first and second ends outwardly of said tube, said back side including a back wall including an upper edge and lower edge, each of said stops comprising a slide attached to an associated one of said upper and lower edges, said slides being slidable from the first position adjacent to one of said side walls to said second position spaced from said side walls and extending over an associated one of said top and bottom ends; and
an adhesive pad being coupled to said back side and being configured for removably adhering the tube to a back surface of the personal electronic device.
